(19) United States
(12) Patent Application Publication
(10) Pub. No.: US 2003/0066219 A1
(43) Pub. Date: Apr. 10, 2003

(54) Wrap-around printable label

(76) Inventor: Joseph Nicholas Palumbo, Saint Laurent (CA)

Correspondence Address: Mr. John Bermingham, Centis Canada, Inc., 205 South Puente, Brea, CA, 92821, US

(21) Appl. No.: 09/972,722

(22) Filed: Oct. 5, 2001

(51) Int. Cl. B42F 21/00; G09F 23/10

(52) U.S. Cl. 40/359; 40/641

(57) ABSTRACT

Wrap-around, printable label for application to a tab of an index or agenda divider or the edge of a folder, other sheet or envelope. The invention allows for the placement of desired text on both sides of the tab without having to print two labels and substantially eliminates the alignment problems associated with prior art techniques.

### FIELD OF THE INVENTION

The present invention relates to labels for index divider systems and, more particularly, to wrap-around, printable labels for index divider tabs, file folders, agendas and envelopes.

### BACKGROUND OF THE INVENTION

Three-ring binders, report covers, agendas and the like are often organized with the use of index dividers having tabs extending therefrom. Index dividers are typically made of card stock or light plastic and are usually wider than the pages held within the binder or report cover. For example, an index divider for standard letter-size pages is about one-half inch wider and taller than a standard letter-size page.

Laser and ink-jet printers have spawned a wide variety printing options allowing users to create highly-customized, professional looking reports. However, the overall dimensions of index dividers make it impractical to print directly on the index divider tab with a laser or ink-jet printer. Accordingly, to place text on a tab, a user either writes directly on the tab or prints desired text on a label and applies the label to the tab. To achieve a more polished look, a user may even use a laser printer to print the labels. After the sheet of labels passes through the printer, the user peels off the label and applies it to one side of the tab. To place desired text on both sides of the tab, however, the labels and systems of the prior art require the user to print two separate labels and apply them separately to both sides of the tab. Such a configuration often does not achieve the desired aesthetic effect, however, in that either one or both of the labels are misaligned on the tab.

In light of the foregoing, a need in the art exists for a label for a tab of an index divider or other sheet that eliminates the alignment problems of the prior art and the need to print two separate labels.

### SUMMARY OF THE INVENTION

The present invention provides a wrap-around, printable label for application to a tab of an index divider, and agenda divider, or the edge of a folder, other sheet or envelope. The invention allows for the placement of desired text on both sides of the tab, folder or sheet without having to print two labels and substantially eliminates the alignment problems associated with prior art techniques.

### DESCRIPTION OF THE DRAWINGS

FIG. 1 is a plan view of a sheet of printable labels according to one embodiment of the present invention.

FIG. 2 is a plan view of an index divider sheet including a tab.

### DESCRIPTION OF PREFERRED EMBODIMENT(S)

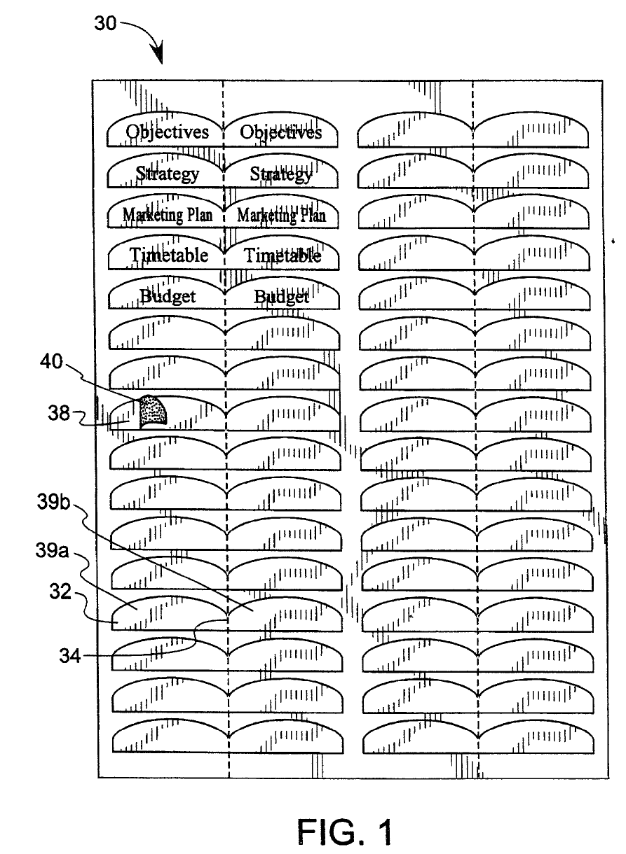

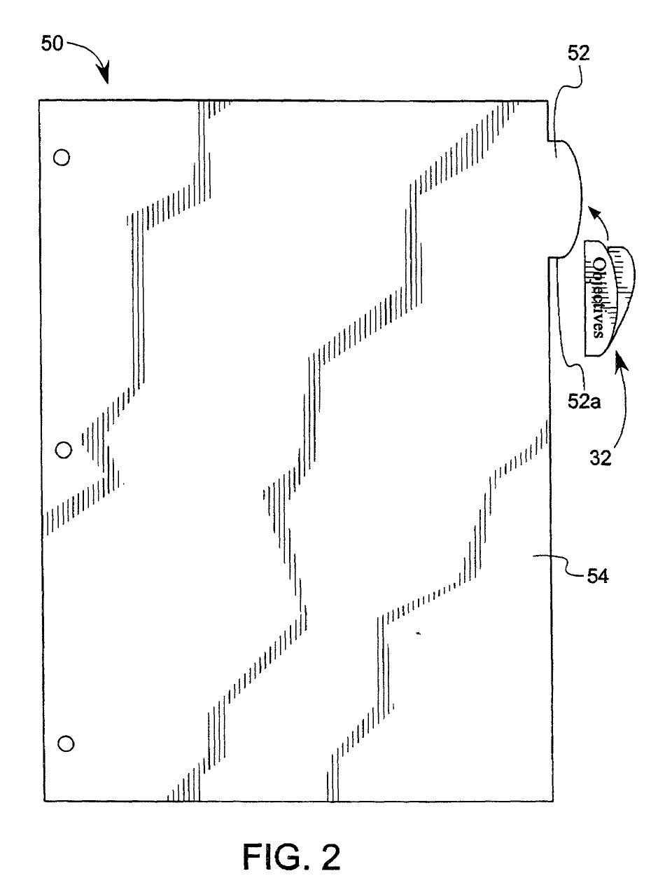

FIGS. 1 and 2 illustrate an embodiment of the present invention. As FIG. 1 shows, an embodiment of the present invention comprises a label sheet assembly 30 including labels 32 each having a fold line 34 extending substantially across the center of the label. Specifically and in one embodiment, the label sheet assembly 30 comprises at least one label 32 having a fold line 34 extending across the center of the label 32 and dividing label 32 into substantially matching halves 39A and 39B. One surface of label 32 includes adhesive layer 40 which releasably secures label 32 to release sheet 38 as is conventional in the art. The opposite surface of label 32 is capable of being printed on by an ink-jet or laser printer. To that end, label sheet assembly 30 is dimensioned for insertion into an ink-jet or laser printer.

Fold line 34 can be a series of score marks (see FIG. 1), a pre-formed crease, indentation line or any other suitable means for providing a pre-formed fold line in label 32. As shown in FIG. 1, fold line 34 extends vertically down the center of label 32. In other embodiments, fold line 34 may be oriented horizontally across the center of the label (not shown).

FIG. 2 illustrates index divider 50 for use with label 32. However, the wrap-around printable label 32 can also be used on non-tabbed items such as a file folder cover or envelope to provide printed matter on both sides of the cover. Accordingly, label 32 may be configured in various dimensions without departing from the scope of the invention. For example, the label for use with a folder cover may be 2″×4″ and include an off-center fold line.

In one embodiment, index divider 50 includes main divider sheet 54 and tab 52 extending from the outer edge of sheet 54. In a preferred form, the outline of tab 52 substantially matches the respective outlines of label halves 39A and 39B. However, the outlines of tab 52 and label 32 need not be matching. In one form, the outline of tab 52 includes a substantially straight section 52A facilitating registration and alignment of label 32 with tab 52. As FIG. 2 shows, the inner edge of main divider sheet 54 includes holes oriented in a standard three-hole punch configuration to allow for insertion of index divider 50 into a three-ring binder. Other binding configurations, however, are possible. For example, index divider may be bound into a report using a binder comb or any other suitable binding means. In addition, the overall dimensions of index divider 50 and the tab can vary depending on the particular application (e.g., letter-size pages, legal-size, A4, etc.).

In use, a user prints on label 32 by hand-writing desired text or graphics on label halves 39A and 39B. In another embodiment, the user may insert label sheet assembly 30 into a standard type writer and type desired text on label halves 39A and 39B. In a preferred form, however, a user employs word processing software, such as Microsoft Word® or Corel WordPerfect®, with a template appropriate for label sheet assembly 30. Using the template, the user inputs desired text or graphics in the appropriate spaces. To print on the labels, the user inserts label sheet assembly 30 into a laser or ink-jet printer and selects the “print” command.

With desired text or graphics printed on the label halves 39A and 39B, the user peels label 32 from release sheet 38 and places it on tab 52 of index divider 50. In one embodiment, the user aligns label 32 relative to tab 52 by aligning fold line 34 with straight section 52A, and folding and then applying pressure to label halves 39A and 39B to adhere them to tab 52. Accordingly, use of the present invention results in desired text appearing on both sides of tab 52.

As one skilled in the art will recognize, the present invention is capable of myriad embodiments and configurations. For example, the orientation of fold line 34 can be adjusted to allow for registration of label 32 along the top, bottom or outer side edge of tab 52 (bottom edge shown in FIG. 2). Furthermore, label 32 can be any suitable material and any desired color. Moreover, label 32 may be individually presented on a release sheet or collectively presented on a standard letter-sized sheet for use with laser or ink-jet printers. Accordingly, the present invention has been described with reference to specific embodiments. Other embodiments of the present invention will be apparent to one of ordinary skill in the art. It is, therefore, intended that the claims set forth below not be limited to the embodiments described above.

What is claimed is:

1. An article of manufacture comprising
a release sheet,
at least one label having a first surface and a second surface,
the first surface having adhesive thereon releasably securing the label to the release sheet,
the second surface capable of being printed on,
the label having a fold line extending there through.

2. The article of claim 1 wherein the fold line extends vertically through the center of the label.

3. The article of claim 1 wherein the fold line extends horizontally through the center of the label.

4. The article of claim 1 wherein the fold line is a crease.

5. The article of claim 1 wherein the fold line comprises a series of score marks.

6. The article of claim 1 wherein the fold line divides the label into substantially matching halves.

7. An article according to claim 6 further comprising an index divider having a tab extending from an edge thereof.

8. An article and divider according to claim 7 wherein the outlines of the substantially matching halves substantially mirror the outline of the index divider tab.

9. An article and divider according to claim 7 wherein the index divider tab includes a straight section substantially matching the fold line in the label.

10. An article and divider according to claim 8 wherein the tab includes a straight section substantially matching the fold line in the label.

11. A label for application to an index divider tab comprising
a first label half and a second label half joined at a fold line,
wherein each label half has a first surface and a second surface,
the first surface having adhesive thereon,
the second surface capable of being printed on.

12. The label according to claim 11 further comprising a release sheet, wherein the adhesive on the second surface releasably secures the label to the release sheet.

13. The label according to claim 11 wherein the first label half substantially matches the second label half.

14. The label according to claim 11 wherein the fold line is a crease.

15. The label according to claim 11 wherein the fold line comprises a series of score marks.

16. The label according to claim 11 wherein the fold line is an indentation.

17. A label according to claim a further comprising at least one index divider having a tab extending therefrom.

18. A label and divider according to claim 17 wherein the respective outlines of the first and second label halves substantially mirror the outline of the divider tab.

19. A label and divider according to claim 18 wherein the divider tab includes a straight section substantially matching the fold line.

20. A labeling system comprising
at least one support selected from the group consisting of an index divider, an agenda divider, a file folder, sheet or envelope;
at least one label for application to said support comprising
a first label half and a second label half joined at a fold line,
wherein each label half has a first surface and a second surface,
the first surface having adhesive thereon,
the second surface capable of being printed on.
